(19) United States
(12) Patent Application Publication
(10) Pub. No.: US 2010/0144576 A1
(43) Pub. Date: Jun. 10, 2010

(54) DISH DETERGENT

(76) Inventors: Thomas Klein, Heidelberg (DE); Ralf-Johann Moritz, Neuss (DE); Thomas Staffel, Grunstadt (DE); Jürgen Straub, Mannheim (DE)

Correspondence Address: PEPPER HAMILTON LLP, ONE MELLON CENTER, 50TH FLOOR, 500 GRANT STREET, PITTSBURGH, PA, 15219, US

(21) Appl. No.: 12/523,673

(22) PCT Filed: Jan. 18, 2008
(86) PCT No.: PCT/EP2008/050541

§ 371 Date: Jan. 27, 2010

(30) Foreign Application Priority Data
Jan. 19, 2007 (DE) 10 2007 003 885.4
Jan. 10, 2008 (DE) 10 2008 000 029.9

(51) Int. Cl. C11D 3/395

(52) U.S. Cl. 510/228

(57) ABSTRACT

The present invention relates to the use of a reduced-phosphate builder system based on alkali metal tripolyphosphate and sodium iminodisuccinate for producing material-protective dishwashing detergent formulations for automatic machine dishwashing.

The present invention relates to the use of a reduced-phosphate builder system based on alkali metal tripolyphosphate and sodium iminodisuccinate for producing material-protective dishwashing detergent formulations for automatic machine dishwashing.

Reduced-phosphate formulations are those whose phosphate content is insufficient to bind the maximum total hardness resulting from the water hardness and the hardness-forming ions of the dishware soil in the wash liquor and which compensate for this gap with a complexing agent which does not belong to the group of the phosphates. Sufficient contents of tripolyphosphate have been found to be approx. 50% (+/−5%). Reduced-phosphate formulations in the sense of the present invention are thus characterized by a phosphate content of less than 45%, preferably from 0.01 to 44.9%.

In the cleaning of dishware in machine dishwashers, the dishware is freed of the soil which consists of a wide variety of different food residues during the washing operation. Compared to washing by hand, dishwashing in machine dishwashers proceeds at a higher pH and a higher temperature, preferably between 45 and 70° C. Fatty and oily stains are hydrolysed in the alkaline medium used and thus removed from the ware. Coloured stains, for example tea stains, are removed by oxidation by a bleach system. Starch and protein constituents are cleaved hydrolytically by enzymes and thus removed more easily. Surfactants play a role as wetting agents only in a low concentration and, in contrast to the manual dishwashing detergents, have to be low-foaming.

The formulations with a high salt content can, however, lead to visible residues on the cleaned dishware. Therefore, in automatic wash programmes of machine dishwashers, the washing operation is separated from the rinsing operation. For this purpose, quite different products have been developed: the machine dishwashing detergent and the rinse aid. The system is supplemented by the so-called regenerating salt for softening by ion exchange.

As a fourth product, the “machine care compositions” came onto the market, which, after a particular number of cycles, are intended to clean and care for the machine themselves. The final compositions to date are fragrances, referred to as deodorants, as the fifth element. The different components are in recent times being integrated or combined into dishwashing tablets, for example “3 in 1” or “5 in 1”.

According to Hauthal, Wagner, Reinigungs- und Pflegemittel im Haushalt [Cleaning and care compositions in the household], Verlag für Chemische Industrie, Augsburg, 2003, ISBN 3-87846-230-1, pages 161-168, the requirements on machine dishwashing compositions are as follows:
Very good grease detachment capacity
Swelling and soil detachment capacity for protein- and starch-containing soil
Removal of intensely coloured stains
Reduction of microbe counts
Low foam
Residue- and spot-free dishware after the wash
Material protection (glass, porcelain, stainless steel, silver)
Storage stability
Favourable environmental properties

The first products for machine dishwashing consisted of more than 90% sodium tripolyphosphate (NTPP), of approx. 3% sodium metasilicate for increasing the alkalinity and as corrosion protection, and contained sodium trichloroisocyanurate as a bleach.

As a result of the alkalinity of NTPP and metasilicate, detachment of the greasy soil by hydrolysis of the greases could be ensured; moreover, NTPP combines good complexation capacity for calcium and magnesium ions with protection of glass, porcelain and metal.

For ecological reasons (phosphates have eutrophying action on water bodies), the phosphate content had initially been lowered and replaced by sodium metasilicate. However, the highly corrosive action of the metasilicates resulted in an accident risk in the household. The consequence was that the first phosphate-free, low-alkalinity machine dishwashing detergents formulated with citrate came onto the market in 1991. However, there were a considerable number of complaints regarding unsatisfactory wash results and corrosion damage to sensitive glasses and decoration on glass. Therefore, leading manufacturers of machine dishwasher recommended as early as 1995 a return to phosphate-containing formulations which bleach with oxygen. In 1999, the phosphate-containing formulations which bleach with oxygen again had a market share of approx. 90% in Germany. The role of the tripolyphosphate as a complexing agent could not be assumed adequately either by metasilicate or by citrate.

The demand for a phosphate replacement which might completely or partly assume the function of the NTPP still exists. Even a partial replacement of NTPP would have a favourable effect on eutrophication. This route is also supported by economic reasons, since phosphates are cheaper than organic complexing agents.

In the last few years, biodegradable organic complexing agents with low toxicity have been developed. Examples of universally usable products include the medium-strength complexing agent sodium iminodisuccinate (Na-IDS) and the stronger complexing agent sodium methylglycinediacetate (Na-MGDA). These complexing agents have likewise been used for phosphate-free dishwashing detergents.

U.S. Pat. No. 3,697,453 A describes the use of reduced-phosphate builder systems with salts of iminodisuccinic acid and up to 40% polyphosphates for producing machine dishwashing detergents.

WO 2006/029806 describes such a phosphate-free formulation for use as a detergent formulation for machine dishwashing. This formulation contains 1 to 20% by weight of copolymers which are formed from the monomers maleic acid, maleic anhydride and acrylic acid, and from isobutene, styrene, etc. As a preferred complexing agent, methylglycinediacetic acid/MGDA and/or its sodium salts are claimed. Copolymers based on maleic acid/acrylic acid, which may also be hydrophobized, together with the complexing agents, form the builder system in many detergent formulations.

However, the action of this formulation was unsatisfactory. In the case of strong complexing agents such as the sodium salt of methylglycinediacetic acid, Na-MGDA, problems occurred with regard to material protection of the surface to be cleaned. The glaze colours on the dishware were attacked and became pale after a few cleaning cycles.

The question therefore arose as to which builder systems are suitable for the machine washing of dishware and are material-protective on the one hand but, on the other, at least approach the level of the phosphate-containing (or phosphate-free) detergents in their cleaning performance. Material-protective in the context of the present invention means especially corrosion protection with respect to colour designs or glazes on the dishware to be cleaned, which may preferably consist of glass, porcelain, metal, earthenware or plastic.

It has been found, surprisingly, that a mixture or combination consisting of an amount of 0.1 to 54.9% by weight of alkali metal tripolyphosphate, preferably sodium tripolyphosphate/NTPP, and 0.1 to 54.9% by weight of sodium iminodisuccinate Na-IDS (sodium salt of imidosuccinic acid) achieved an outstanding test result with regard to cleaning performance on the one hand and material protection on the other hand in the comprehensive test series.

The present application therefore provides for the use of a combination of
a) 25 to 54.9% by weight of alkali metal tripolyphosphate, preferably sodium tripolyphosphate (NTPP), and
b) 0.1 to 30% by weight of sodium iminodisuccinate (Na-IDS) for producing a reduced-phosphate builder system for material-protective dishwashing detergent formulations which can be employed in automatic machine dishwashing appliances.

In a preferred embodiment, the builder system to be used in accordance with the invention contains 25 to 40% by weight of component a) and 15 to 30% by weight of component b), more preferably 25 to 35% by weight of component a) and 15 to 25% by weight of component b). According to the invention, alkali metal is understood to mean potassium and sodium.

The inventive combination of a) and b) for use in dishwashing detergents is surprising because this combination reaches the level of classical, exclusively phosphate-containing formulations, especially because Na-IDS, among the complexing agents, is classified only as a medium-strength complex and the person skilled in the art would have to have assumed that Na-IDS does not exhibit the desired success on use in dishwashing appliances. The inventive combination of a) and b) in the amounts of the individual components specified exhibits corrosion behaviour significantly improved over the prior art with respect to the material to be cleaned, compared to the combinations known from the prior art, which meet the legal requirements on a modern reduced-phosphate dishwashing detergent.

The mixture to be used in accordance with the invention may, as well as the two main constituents, alkali metal tripolyphosphate and Na-IDS as complexing agents, preferably NTPP and Na-IDS, also comprise further constituents which promote or improve the action of the two. These constituents include polymers and copolymers (which may also be hydrophobized), such as polyacrylic acid or its salts, copolymers of acrylic acid with other comonomers or their salts, polycarboxylates based on polyaspartic acid or their salts, carboxymethylcellulose or its salt, oxidized starch or cellulose, metasilicates, sheet silicates, orthosilicates, carbonates or hydrogencarbonates. The complexing agents to be used in accordance with the invention may, as well as Na-IDS, also comprise one or more complexing agents from the group of nitrilotriacetic acid and its salts, hydroxyethylenediaminetriacetic acid and its salts, ethylenediaminetetraacetic acid and its salts, diethylenetriaminepentaacetic acid and its salts, methylglycinediacetic acid and its salts, glutaminediacetic acid and its salts, hydroxyiminodisuccinic acid and its salts, ethylenediaminedisuccinic acid and its salts, aspartic acid diacetate and its salts.

The inventive dishwasher detergent formulations for machine dishwashing comprise, in addition to the combination of components a) and b) to be used in accordance with the invention, also
c) 1 to 15% by weight, preferably 1 to 10% by weight, of low-foaming nonionic surfactants and
d) 0.1 to 30% by weight, preferably 1 to 20% by weight, of bleaches and optionally bleach activators.

In a further alternative embodiment, the inventive dishwasher detergent formulations may additionally also comprise
e) 0.1 to 60% by weight, preferably 0.1 to 40% by weight, of further builders.

In a further alternative embodiment, the inventive dishwashing detergent formulations, in addition to components a) to d) and e), or instead of e), may also comprise
f) 0.1 to 8% by weight, preferably 0.1 to 5% by weight, of enzymes, preferably proteases, amylases or lipases.

In a further alternative embodiment, the inventive dishwashing detergent formulations, in addition to components a) to d) and optionally e) and/or f), or instead of one of components e) or f), may additionally comprise
g) 0.1 to 50% by weight, preferably 0.1 to 45% by weight, of one or more further additives such as anionic or zwitterionic surfactants, bleach catalysts, alkali carriers, corrosion inhibitors, defoamers, dyes, fragrances, fillers, organic solvents or water.

The sum of components a) to g), within the combinations of the inventive detergent formulations possible in each case, always adds up to 100% by weight.

The formulation may be processed as a tablet, powder, gel, capsule or solution. The formulations may either be those for domestic applications or for commercial applications. Cleaning appliances in which the combination of components a) and b) to be used in accordance with the invention or the detergent formulations obtainable therefrom are domestic machine dishwashers, machine dishwashers in large kitchens, and machine dishwashers on ships, in vehicles and aircraft, but also apparatus cleaning machines in medical or chemical laboratories.

As component c), the inventive detergent formulations comprising components a) to d) comprise weakly foaming or low-foaming nonionic surfactants. These are generally present in proportions of 0.1 to 20% by weight, preferably 0.1 to 15% by weight, more preferably 0.25 to 10% by weight.

Low-foaming or weakly foaming nonionic surfactants are preferably end group-capped fatty alkyl ethoxylates and are obtainable from fatty alcohols and differently arranged ethylene oxide and propylene oxide/butylene oxide blocks (J. Tropsch, H. Gümbel, G. Oetter, New low-foaming surfactants for dishwasher detergents and rinse aids, SÖFW J. 2001, 127, H. 11, 2-5).

Preferred nonionic surfactants include the surfactants of the general formula (I)

R²—O—(CH₂CH₂O)ₚ—(CHR¹CH₂O)ₘ—R³ (I)

in which
R² is a linear or branched alkyl radical having 8 to 22 carbon atoms,
R¹ and R³ are each independently hydrogen or a linear or branched alkyl radical having 1 to 10 carbon atoms or H, where R¹ is preferably methyl,
p and m are each independently 0 to 300.
p is more preferably an integer of 1 to 5 and m an integer of 0 to 30.

The surfactants of the formula (I) may either be random copolymers or block copolymers; they are preferably block copolymers.

It is additionally possible to use di- and multiblock copolymers formed from ethylene oxide and propylene oxide, which are commercially available, for example, under the name Pluronic® (BASF Aktiengesellschaft) or Tetronic® (BASF Corporation). It is additionally possible to use reaction products of sorbitan esters with ethylene oxide and/or propylene oxide. Likewise suitable are amine oxides or alkylglycosides. An overview of suitable nonionic surfactants is given by EP-A 0 851 023 and DE-A 198 19 187.

The formulations may further comprise anionic or zwitterionic surfactants, preferably in a blend with nonionic surfactants. Suitable anionic and zwitterionic surfactants are likewise specified in EP-A 851 023 and DE-A 198 19 187.

As component d), the inventive dishwashing detergent formulations comprising components a) to d) comprise bleaches and optionally bleach activators.

Bleaches are divided into oxygen bleaches and chlorine bleaches. Use as oxygen bleaches is found by alkali metal perborates and their hydrates, and also alkali metal percarbonates. Preferred bleaches in this context are sodium perborate in the form of the mono- or tetrahydrate, sodium percarbonate or the hydrates of sodium percarbonate.

Likewise usable as oxygen bleaches are persulphates and hydrogen peroxide.

Typical oxygen bleaches are also oxygen peracids, for example perbenzoic acid, peroxy-alpha-naphthoic acid, peroxylauric acid, peroxystearic acid, phthalimidoperoxycaproic acid, 1,12-diperoxydodecanedioic acid, 1,9-diperoxyazelaic acid, diperoxoisophthalic acid or 2-decyl-diperoxybutane-1,4-dioic acid.

In addition, it is also possible for the following oxygen bleaches to find use in an inventive dishwashing detergent formulation:

Cationic peroxy acids which are described in patent applications U.S. Pat. No. 5,422,028, U.S. Pat. No. 5,294,362 and U.S. Pat. No. 5,292,447; sulphonylperoxy acids which are described in patent application U.S. Pat. No. 5,039,447.

Oxygen bleaches are used in amounts of generally 0.5 to 30% by weight, preferably of 1 to 20% by weight, more preferably of 3 to 15% by weight, based on the overall dishwashing detergent formulation.

Chlorine bleaches and the combination of bleaches with peroxide bleaches may likewise be used. Known chlorine bleaches are, for example, 1,3-dichloro-5,5-dimethylhydantoin, N-chloro-sulphamide, chloramine T, dichloramine T, chloramine B, N,N′-dichlorobenzoylurea, p-toluene-sulphonyldichloramide or trichloroethyleneamine. Preferred chlorine bleaches are sodium hypochlorite, calcium hypochlorite, potassium hypochlorite, magnesium hypochlorite, potassium dichloroisocyanurate or sodium dichloroisocyanurate.

Chlorine bleaches are used in amounts of generally 0.1 to 20% by weight, preferably 0.2 to 10% by weight, more preferably 0.3 to 8% by weight, based on the overall dishwashing detergent formulation.

In addition, it is possible to add small amounts of bleach stabilizers, for example phosphonates, borates, metaborates, metasilicates or magnesium salts.

Bleach activators are compounds which, under perhydrolysis conditions, give rise to aliphatic peroxocarboxylic acids having preferably 1 to 10 carbon atoms, especially 2 to 4 carbon atoms, and/or substituted perbenzoic acid. Suitable compounds are those which contain one or more N- or O-acyl groups and/or optionally substituted benzoyl groups, for example substances from the class of the anhydrides, esters, imides, acylated imidazoles or oximes. Examples are tetraacetylethylenediamine (TAED), tetraacetylmethylenediamine (TAMD), tetraacetylglycoluril (TA-GU), tetraacetylhexylenediamine (TAHD), N-acylimides, for example N-nonanoyl-succinimide (NOSI), acylated phenolsulphonates, for example n-nonanoyl- or isononanoyloxy-benzenesulphonates (n- or iso-NOBS), pentaacetylglucose (PAG), 1,5-diacetyl-2,2-dioxo-hexahydro-1,3,5-triazine (DADHT) or isatoic anhydride (ISA). Likewise suitable as bleach activators are nitrile quats, for example N-methylmorpholinoacetonitrile (MMA salts) or trimethyl-ammonioacetonitrile salts (TMAQ salts).

Bleach activators suitable with preference are those from the group consisting of polyacylated alkylenediamines, more preferably TAED, N-acylimides, more preferably NOSI, acylated phenol-sulphonates, more preferably n- or iso-NOBS, MMA and TMAQ.

It is also possible for the following substances to find use as bleach activators in inventive dishwashing detergent formulations comprising components a) and b), and also c) and d):

Carboxylic anhydrides, for example phthalic anhydride; acylated polyhydric alcohols, for example triacetin, ethylene glycol diacetate or 2,5-diacetoxy-2,5-dihydrofuran; the enol esters known from DE-A 19 616 693 and DE-A 19 616 767, and also acylated sorbitol and mannitol and their mixtures described in EP-A 0 525 239; acylated sugar derivatives, especially pentaacetylglucose (PAG), pentaacetylfructose, tetraacetylxylose and octaacetyllactose, and also acylated, optionally N-alkylated glucamine and gluconolactone, and/or N-acylated lactams, for example N-benzoyl-caprolactam, which are known from documents WO 94/27 970, WO 94/28 102, WO 94/28 103, WO 95/00 626, WO 95/14 759 and WO 95/17 498.

The hydrophilically substituted acyl acetals detailed in DE-A 19 616 769 and the acyl lactams described in DE-A 19 616 770 and WO 95/14 075 may be used, as may the combination of conventional bleach activators known from DE-A 44 43 177.

Bleach activators are used in amounts of generally 0.1 to 10% by weight, preferably of 1 to 9% by weight, more preferably of 1.5 to 8% by weight, based on the overall dishwashing detergent formulation.

As component e), the inventive dishwashing detergent formulation comprising components a) to d) may comprise further builders. It is possible to use water-soluble and water-insoluble builders whose main task consists in the binding of calcium and magnesium.

The further builders used may be:

Copolymers a) of
a1) at least one monomer from the group consisting of monoethylenically unsaturated C₃-C₁₀-mono- or dicarboxylic acids or their anhydrides,

optionally with a2) at least one monomer of the general formula (II),

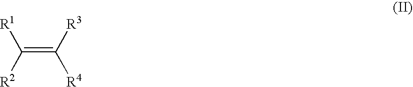

where
R¹, R² and R³ are each independently H, CH₃ or C₂H₅,
R⁴ is a linear, branched or cyclic radical having 1 to 6 carbon atoms or an aromatic radical having 6 to 12 carbon atoms,

or optionally with a3) at least one further monomer selected from the group consisting of olefins having 10 or 100 carbon atoms, or low molecular weight carboxylic acids and salts thereof, such as alkali metal citrates, especially anhydrous trisodium citrate, or trisodium citrate dihydrate, alkali metal succinates, alkali metal malonates, fatty acid sulphonates, oxydisuccinate, alkyl or alkenyl disuccinates, gluconic acids, oxadiacetates, carboxymethyloxysuccinates, tartrate monosuccinate, tartrate disuccinate, tartrate monoacetate, tartrate diacetate, α-hydroxypropionic acid;

oxidized starches, oxidized polysaccharides,

homo- and copolymeric polycarboxylic acids and salts thereof, such as polyacrylic acid, polymethacrylic acid, copolymers of maleic acid and acrylic acid,

graft polymers of monoethylenically unsaturated mono- and/or dicarboxylic acids onto mono-saccharides, oligosaccharides, polysaccharides or polyaspartic acid; aminopolycarboxylates and polyaspartic acid;

phosphonates such as 2-phosphono-1,2,4-butanetricarboxylic acid, aminotri(methylenephosphonic acid), 1-hydroxyethylene(1,1-diphosphonic acid), ethylenediamintetramethylenephosphonic acid, hexamethylenediaminetetramethylenephosphonic acid or diethylenetriaminepentamethylene-phosphonic acid;

silicates such as sodium disilicate and sodium metasilicate;

water-soluble builders such as zeolites and crystalline sheet silicates.

Preferred monomers a1) are, for example, maleic acid, maleic anhydride, acrylic acid, methacrylic acid, fumaric acid, itaconic acid and citraconic acid. Preferred copolymers a) contain, as monomers a1), monomers which are selected from the group consisting of maleic acid, maleic anhydride and acrylic acid.

Preferred monomers a2) to be used optionally are, for example, isobutene, diisobutene, butene, pentene, hexene and styrene. Further preferred copolymers a) contain, as monomers a2), monomers which are selected from the group consisting of isobutene, diisobutene (2-methyl-3,3-dimethyl-1-butene) and styrene.

Preferred monomers a3) to be used optionally have at least 10, preferably 10-26, carbon atoms.

Particularly preferred monomers a3) are 1-decene, 1-dodecane, 1-tetradecene, 1-hexadecene, 1-octadene, 1-eicosene, 1-docosene, 1-tetracosene and 1-hexacosene. Further preferred copolymers a) contain, as monomers a3), monomers which are selected from the group consisting of 1-dodecene, 1-octadecene, C₂₂-α-olefins and polyisobutene having an average of 12 to 100 carbon atoms.

Very especially preferred copolymers a) contain monomers a1) which are selected from maleic acid, maleic anhydride and acrylic acid, and also monomers a2) which are selected from isobutene, diisobutene and styrene, and also monomers a3) which are selected from the group consisting of 1-dodecene, 1-octadecene, C₂₂-α-olefin, a mixture of C₂₀-C₂₄-α-olefins and polyisobutene having an average of 12 to 100 carbon atoms. Especially preferred copolymers are those composed of 30 to 70% by weight of maleic acid and maleic anhydride as monomers a1), 20 to 40% by weight of isobutene as monomer a2) and 5 to 20% by weight of octadecene as monomer a3).

As component f), the inventive dishwashing detergent formulations comprising components a) to d) may comprise enzymes. It is possible to add to the dishwashing detergent between 0.1 and 8% by weight of enzymes, based on the overall formulation, in order to enhance its performance or to ensure cleaning performance in the same quality under milder conditions. The most frequently used enzymes include lipases, amylases, cellulases and proteases. In addition, it is also possible, for example, to use esterases, pectinases, lactases and peroxidases.

The inventive dishwashing detergent formulations comprising components a) to d) may additionally comprise, as component g), further additives such as anionic or zwitterionic surfactants. bleach catalysts, alkali carriers, corrosion inhibitors, defoamers, dyes, fragrances, fillers, organic solvents and water.

In addition to the conventional bleach activators detailed above or in their stead, it is also possible for the sulphonimines known from EP-A 446 982 and EP-A 453 003 and/or bleach-boosting transition metal salts or transition metal complexes as so-called bleach catalysts to be present in the inventive dishwashing detergent formulations.

The useful transition metal compounds include, for example, the manganese, iron, cobalt, ruthenium or molybdenum complexes known from DE-A 19 529 905 and their N-analogue compounds known from DE-A 19 620 267, the manganese carbonyl, iron carbonyl, cobalt carbonyl, ruthenium carbonyl or molybdenum carbonyl complexes known from DE-A 19 536 082, the manganese, iron, cobalt, ruthenium, molybdenum, titanium, vanadium and copper complexes with nitrogen-containing tripod ligands, said complexes being described in DE-A 19 605 688, the cobalt-, iron-, copper- and ruthenium-amine complexes known from DE-A 19 620 411, the manganese, copper and cobalt complexes described in DE-A 4 416 438, the cobalt complexes described in EP-A 272 030, the manganese complexes known from EP-A 693 550, the manganese complexes described in EP-A 443 651, EP-A 458 397, EP-A 458 398, EP-A 549 272, EP-A 544 490 and EP-A 544 519. Combinations of bleach activators and transition metal bleach catalysts are known, for example, from DE-A 19 613 103 and WO 95/27 775.

Binuclear manganese complexes which contain 1,4,7-trimethyl-1,4,7-triazacyclononane (TMTACN), for, example [(TMTACN)₂MN^{IV}Mn^{IV}(μ-O)₃]²⁺(PF₆⁻)₂, are likewise suitable as effective bleach catalysts. These manganese complexes are likewise described in the aforementioned documents.

Suitable bleach catalysts are preferably bleach-boosting transition metal complexes or transition metal salts from the group consisting of the manganese salts and complexes and the cobalt salts and complexes. More preferably suitable are the cobalt(amine) complexes, the cobalt(acetate) complexes, the cobalt(carbonyl) complexes, the chlorides of cobalt or of manganese, manganese sulphate or [(TMTACN)₂Mn^{IV}Mn^{IV}(μ-O₃]²⁺(PF₆⁻⁾₂.

Bleach catalysts may be used in amounts of 0.0001 to 5% by weight, preferably of 0.0025 to 1% by weight, more preferably of 0.01 to 0.25% by weight, based on the overall dishwashing detergent formulation.

As further constituents of the inventive dishwashing detergent formulations comprising components a) to d), alkali carriers may be present. Alkali carriers include ammonium hydroxides and/or alkali metal hydroxides, ammonium carbonates and/or alkali metal carbonates, ammonium hydrogencarbonates and/or alkali metal hydrogencarbonates, ammonium sesquicarbonates and/or alkali metal sesquicarbonates, ammonium metasilicates and/or alkali metal metasilicates, and mixtures of the aforementioned substances, preference being given to using ammonium carbonates and/or alkali metal carbonates, especially sodium carbonate, sodium hydrogencarbonate or sodium sesquicarbonate.

The corrosion inhibitors used may be silver protectants from the group of the triazoles, of the benzotriazoles, of the bisbenzotriazoles, of the aminotriazoles, of the alkylaminotriazoles and of the transition metal salts or complexes. Particular preference is given to using benzotriazole and/or alkylaminotriazole. In addition, active chlorine-containing agents which significantly reduce the corrosion of the silver surface are frequently used in dishwashing detergent formulations. In chlorine-free detergents, preference is given to using oxygen- and nitrogen-containing organic redox-active compounds such as di- and trihydric phenols, for example hydroquinone, pyrocatechol, hydroxyhydroquinone, gallic acid, phloroglucinol, pyrogallol and derivatives of these compound classes. Salt- and complex-type inorganic compounds such as salts of the metals Mn, Ti, Zr, Hf, V, Co and Ce also frequently find use. Preference is given here to using the transition metal salts which are selected from the group of manganese and/or cobalt salts and/or complexes, more preferably from the group of the cobalt(amine) complexes, of the cobalt(acetate) complexes, of the cobalt(carbonyl) complexes, of the chlorides of cobalt or of manganese, and of manganese sulphate. It is likewise possible to use zinc compounds or bismuth compounds to prevent corrosion on the ware.

Paraffin oils and silicone oils may be used optimally as defoamers and for protection of plastic and metal surfaces. Preference is given to using defoamers in proportions of 0.001% by weight to 5% by weight. It is also possible to add dyes, for example Patent Blue, preservatives, for example Kathon CG, perfumes or other fragrances, to the inventive dishwashing detergent formulations comprising components a) and b), and also c) and d).

The inventive dishwashing detergent formulations for the machine washing of dishware based on a builder system comprising components a) and b), and also components c) and d), may be used either in powder form or as tabs.

### EXAMPLES

For the following tests, a guide formulation of a low-alkalinity detergent (typical phosphate content) according to Hermann G. Hauthal, G. Wagner (eds.): Reinigungs- und Pflegemittel im Haushalt, Verlag für Chemische Industrie, Augsburg, 2003, ISBN 3-87846-230-1:

### Example 1

| | | |
|---|---|---|
| Pentasodium triphosphate (NTPP) | 45.5% | content |
| Phosphonates (hydroxyethenediamine) | 5% | |
| Sodium polycarboxylates | 6% | |
| Soda | 20% | |
| Sodium disilicate | 5% | |
| Sodium perborate | 10% | |
| Bleach activator TAED (tetraacetylethylenediamine) | 2% | |
| Proteases and amylases | 4% | |
| Low-foaming surfactants | 2% | |
| Silver protectant | 0.2% | |
| Fragrances | 0.2% | |

In this formulation, sodium tripolyphosphate is replaced partly by sodium iminodisuccinate, sodium methylglycinediacetate, trisodium citrate and sodium sulphate.

The washing performance and the material protection of selected combinations was tested.

VN1: base formulation as above (not inventive)

VN 2: NTPP reduced to 30%, supplemented by 15.5% Na-IDS (inventive)

VN 3: NTPP reduced to 30%, supplemented by 15.5% Na-MGDA (not inventive)

VN 4: NTPP reduced to 30%, supplemented by 15.5% Na-citrate (not inventive)

VN 5: NTPP reduced to 25%, supplemented by 20.5% Na-IDS

VN 6: NTPP reduced to 20%, supplemented by 25.5% Na-IDS

VN 7: NTPP reduced to 15%, supplemented by 30.5% Na-IDS

VN 8: NTPP reduced to 10%, supplemented by 35.5% Na-IDS

The results of test series which have been performed with these formulations are complied hereinafter. First the cleaning performance was investigated, working without rinse aid in one test series (R1), and with rinse aid in the second (R2). The cleaning performance was evaluated with a mark system where the mark 1 represents no cleaning action, the mark 10 complete cleaning (=as new).

The percentages for particular soil types are based on a gravimetric determination.

Test Conditions:

Detergent dosage 20 g

Water hardness 8-10° GH

Test series 1 (=R1)

| | VN 1 R1 | VN 2 R1 | VN 3 R1 | VN 4 R1 | VN 5 R1 | VN 6 R1 | VN 7 R1 | VN 8 R1 |
|---|---|---|---|---|---|---|---|---|
| | Mark | Mark | Mark | Mark | Mark | Mark | Mark | Mark |
| Oatmeal | 7.7 | 8.1 | 8.0 | | 7.9 | 7.5 | 7.3 | 6.8 |
| Minced meat | 8.4 | 8.7 | 8.7 | | 7.9 | 6.3 | 5.5 | 4.6 |
| 120° C. | | | | | | | | |
| Milk | 6.5 | 6.4 | 6.5 | | 6.5 | 6.5 | 6.5 | 6.4 |
| Tea | 2.3 | 3.3 | 4.8 | | 3.8 | 4.3 | 4.8 | 5.1 |
| | % | % | % | | % | % | % | % |
| | detachment | detachment | detachment | | detachment | detachment | detachment | detachment |
| Egg/milk | 96 | 97 | 97 | | 97 | 96 | 96 | 97 |
| Egg yolk | 64 | 66 | 68 | | 66 | 68 | 68 | 70 |
| Rice starch | 99 | 99 | 99 | | 99 | 99 | 99 | 99 |

Mark Scale:

Egg yolk, rice, tomato/cheese: 0%=no cleaning action, 100%=completely clean carrier material

Oats, minced meat, tea, milk: 0=no cleaning action, 10=completely clean carrier material In this test series, the lower-phosphate variants had better results for tea than the classical variant.

Test Conditions in the Cleaning Test with Rinse Aid:

Detergent dosage 20 g tab

Water hardness 8-10° GH

Test series 2 (=R2). In the investigation of the cleaning performance, rinse aid was added.

Rinse aid 3 ml of IEC type III

| | VN 1 R2 | VN 2 R2 | VN 3 R2 | VN 4 R2 | VN 5 R2 | VN 6 R2 | VN 7 R2 | VN 8 R2 |
|---|---|---|---|---|---|---|---|---|
| | Mark | Mark | Mark | Mark | Mark | Mark | Mark | Mark |
| Oatmeal | 8.5 | 8.5 | | 8.4 | 8.4 | 8.1 | 7.8 | 7.1 |
| Minced meat | 6.9 | 6.8 | | 3 | 6.1 | 5.3 | 4.2 | 3.5 |
| 120° C. | | | | | | | | |
| Milk | 6.6 | 6.6 | | 6.5 | 6.6 | 6.4 | 6.7 | 6.5 |
| Tea | 7.8 | 7.8 | | 3.5 | 8.2 | 8.4 | 8.5 | 8.7 |
| | % | % | % | % | % | % | % | % |
| | detachment | detachment | detachment | detachment | detachment | detachment | detachment | detachment |
| Egg/milk | 28 | 26 | | 29 | 26 | 27 | 26 | 27 |
| Egg yolk | 33 | 29 | | 19 | 28 | 27 | 28 | 26 |
| Rice starch | 66 | 64 | | 60 | 64 | 64 | 63 | 62 |

In the second series, the cleaning performance with use of a rinse aid was investigated. For the classical formulation and for the NTPP/Na-IDS formulation, better cleaning performances were achieved for tea stains, but not in the case of use of trisodium citrate as a substitute for one third of the phosphate content.

The tests with regard to material protection were performed with a Miele turbothermic G 666 SC machine dishwasher with a 65° C. universal programme. Dosage 20 g tab via detergent drawer, rinse aid 3 ml of IEC type III; the water hardness was 0.1° GH.

| Material | VN1 | VN2 | VN3 | VN4 | VN 5 | VN 6 | VN 7 | VN 8 |
|---|---|---|---|---|---|---|---|---|
| Glass | | | | | | | | |
| Lead crystal | 3.8 | 3.8 | 3.8 | 3.8 | 3.8 | 3.5 | 3.3 | 3.0 |
| Potash crystal | 4.4 | 4.0 | 3.5 | 2.9 | 3.6 | 3.3 | 3.1 | 2.8 |
| soiree | | | | | | | | |
| Decorated glass | | | | | | | | |
| Soda-lime glass | 3.5 | 2.0 | 1.0 | 3.5 | 1.8 | 1.7 | 1.4 | 1.0 |
| Glass | 3.5 | 3.5 | 1.5 | 3.5 | 2.8 | 2.2 | 1.8 | 1.4 |
| Cutlery | | | | | | | | |
| Silver | 5.0 | 5.0 | 5.0 | 5.0 | 5.0 | 5.0 | 4.8 | 4.2 |

Evaluation of the Results:

Mark 5=no material attack/discoloration/iridescence

Mark 4=slight material attack/discoloration/iridescence

Mark 3=low material attack/discoloration/iridescence

Mark 2=high material attack/discoloration/iridescence

Mark 1=very high material attack/discoloration/iridescence

The results show that the inventive reduced-phosphate formulations which comprise the combination of NTPP and Na-IDS to be used in accordance with the invention show distinct differences in material protection. For instance, substitution of only one third of phosphate by Na-MGDA has a clearly unfavourable effect on decorated glass, while the same substitution by Na-IDS brings about lower corrosivity. Even the supposedly gentle citrate exhibited a material-eroding effect in potash crystal.

1. A method for producing material-protective dishwashing detergent formulations for automatic machine dishwashing which comprises adding a reduced-phosphate builder system comprised of
a) 25 to 54.9% by weight of alkali metal tripolyphosphate, and
b) 0.1 to 30% by weight of iminodisuccinic acid and/or its alkali metal salts to said formulations.

2. Method according to claim 1, wherein the builder system, in addition to components a) and b), comprises one or more complexing agents selected from the group consisting of nitrilotriacetic acid and its salts, hydroxyethylenediaminetriacetic acid and its salts, ethylenediaminetetraacetic acid and its salts, diethylenetriaminepentaacetic acid and its salts, methylglycinediacetic acid and its salts, glutaminediacetic acid and its salts, hydroxyiminodisuccinic acid and its salts, ethylenediaminedisuccinic acid and its salts, and aspartic acid diacetate and its salts.

3. Method according to claim 1, wherein the builder system comprises additional constituents selected from the group consisting of polyacrylic acid and its salts, modified polyacrylic acid and its salts, polycarboxylates based on polyaspartic acid and their salts, carboxymethylcellulose and its salts, oxidized starch or cellulose, metasilicates, sheet silicates, ortho silicates, carbonate and hydrogencarbonate.

4. Dishwashing detergent formulations for machine dishwashing, comprising, as a builder system
a) 25 to 54.9% by weight of alkali metal tripolyphosphate, and
b) 0.1 to 30% by weight of iminodisuccinic acid and/or its alkali metal salts, and also
c) 1 to 15% by weight of low-foaming nonionic surfactants and
d) 0.1 to 30% by weight of bleach and optionally bleach activators.

5. Dishwashing detergent formulations according to claim 4, further comprising
e) 0.1 to 60% by weight of further builders.

6. Dishwashing detergent formulations according to claim 4 or 5, further comprising 0.1 to 8% by weight of enzymes.

7. Dishwashing detergent formulations according to claim 4, comprising 0.1 to 50% by weight of one or more further additives.

8. Machine dishwashing process for dishware, wherein said dishware is washer in a washing machine with a dishwashing detergent formulation is used therein which comprises, as a builder system,
a) 25 to 54.9% by weight of alkali metal tripolyphosphate, and
b) 0.1 to 30% by weight of iminodisuccinic acid and/or its alkali metal salts, sodium salts, and also
c) 1 to 15% by weight of low-foaming nonionic surfactants and
d) 0.1 to 30% by weight of bleach and optionally bleach activators.

9. Process according to claim 8, wherein the dishwashing detergent formulation is in the form of a powder or a tablet.

10. The method of claim 1, wherein said tripolyphosphate is sodium tripolyphosphate.

11. Dishwashing detergent of claim 4, wherein said tripolyphosphate is sodium tripolyphosphate.

12. The Machine dishwashing process of claim 8, wherein said tripolyphosphate is sodium tripolyphosphate.
